(19) United States
(12) Patent Application Publication
(10) Pub. No.: US 2020/0410522 A1
(43) Pub. Date: Dec. 31, 2020

(54) Framework to reward real world behaviors in a loyalty program

(71) Applicant: Brandon McCowan, Redlands, CA (US)

(72) Inventor: Brandon McCowan, Redlands, CA (US)

(21) Appl. No.: 16/746,928

(22) Filed: Jan. 19, 2020

Related U.S. Application Data
(60) Provisional application No. 62/784,926, filed on Dec. 26, 2018.

(51) Int. Cl. G06Q 30/02; G06F 16/21

(52) U.S. Cl. CPC G06Q 30/0226; G06F 16/211

(57) ABSTRACT

A framework to bridge various tracking devices such as wearables, credit cards, smart home appliances, and any other internet enabled device with any set of loyalty programs so that upon the completion of a real world activity tracked by a tracking device, a user of such a framework may obtain rewards in one or more loyalty programs. The various tracking devices may be disparate from the loyalty programs and the user may limit the information communicated to the loyalty programs in multiple ways.

### CROSS-REFERENCE TO RELATED APPLICATIONS

This application claims priority from U.S. Provisional Patent Application No. 62/784,926 filed on Dec. 26, 2018. The entire disclosure of the prior application is considered to be part of the disclosure of the accompanying application and is hereby incorporated by reference.

### BACKGROUND OF THE INVENTION

### 1. Field of the Invention

The present disclosure relates, in general, to a framework that allows users to achieve rewards and benefits in enrolled loyalty programs as a result of their activities and actions performed as part of their daily routines in real world settings. The framework allows for one or more tracking devices to communicate with one or more loyalty programs in an indirect manner so that the one or more tracking devices do not need to know which of many loyalty programs are utilizing the information being tracked. Additionally, the framework provides multiple layers of privacy primarily by allowing the user to specify what tracked activities are to be communicated to the many loyalty programs and by categorizing the tracked activity prior to sending the tracked activity to a particular loyalty program.

### 2. Description of the Related Art

Since the release of the Nintendo Wii console in 2006, platforms supporting activity-driven games have provided a compelling experience for players and created a larger connection between physical activity and game progression and achievement. From mobile phones which enable games to leverage the device's built-in accelerometer to Xbox Kinect, which enables full-body tracking, these platforms have encouraged physical activity by supporting motion-based controls. The intended goal is to have fun and exercise at the same, thereby obtaining the best of the real and virtual worlds. Even modern platforms such as Oculus Rift and HTC Vive usually require players to physically move to play.

Platforms that support a larger connection between physical activity and game experience face some inherent challenges to marketplace uptake and longevity. First, controllers which require increased physical activity can conflict with the gaming experience by creating a distraction either because of the active motion itself or the player's physical tiredness. Consider the simple handheld controller which has maintained market dominance over any motion-based controller. Second, gameplay can detract from the quality of physical activity by requiring the players to continuously manipulate a controller, wear a headset, or perform sporadic movements. In the best case scenario, a proper balance must exist between activity and game experience. The present invention describes a system and method to reduce the foregoing challenges.

Many patents have sought to unite a user's real world activities with their online activities including the following United States patents:

U.S. Pat. No. 9,626,475 discloses a system that distributes virtual currency in the game space for performing certain operations in the game space in a given time-period. The currency may then be used to purchase benefits in the game space.

U.S. Pat. No. 9,665,239 discloses a system and method for user progression in a virtual space ability by purchasing virtual currency which may be in a separate, unrelated virtual space ability.

U.S. Pat. No. 9,415,304 discloses a virtual environment which enables synchronous, time-limited cooperation between users and may increase user adoption and retention rate.

U.S. Pat. No. 9,452,356 discloses a system and a method for providing virtual items to users who participate in group affiliations or alliances. Virtual items may be upgraded or cumulatively obtained by the group.

U.S. Pat. No. 9,656,159 discloses a system for providing an alternative to spending virtual currency in place of performing an online activity by performing offline activities instead. The activities may be thematically related to the online activity.

U.S. Pat. No. 9,199,165 discloses a system and methods to automatically record and store game clips for replaying as video game highlights.

U.S. Pat. No. 9,561,433 discloses a system and method for providing rewards in a secondary game based on achievement in an event in the primary game. Rewards may include free or optional turns in the secondary game and are time-sensitive.

U.S. Pat. No. 9,675,891 discloses systems and methods for upgrading the quality and level of virtual items in a game.

U.S. Pat. No. 9,539,502 discloses a system and method for making payments for in-game items based on chance. A user would be drawn from a subgroup raffle to determine who makes the payment for an item that may benefit the whole group.

U.S. Pat. No. 10,086,261 discloses an online racing game that provides players with the opportunity to play in individual episodes of the game.

U.S. Pat. No. 9,582,965 discloses a system and method for providing users with virtual items based on the quantity of virtual items already existing in their inventory. Reward opportunities are time-limited.

U.S. Pat. No. 10,022,632 discloses a system for making financial investments indirectly through a game interface where the real-world investment opportunities are a secondary benefit of playing the game.

U.S. Pat. No. 9,669,296 discloses a system for rewarding real word activity with a location-based parallel reality game. The game may encourage real world activity such as commercial or collection activity.

U.S. Pat. No. 9,613,179 discloses a system for providing an event space to users where they may complete event objectives, and purchase or receive virtual items during an event period. Progress in the event space may allow use of an event item in a primary virtual space.

U.S. Pat. No. 9,403,093 discloses a system to incentivize cross platform game play by offering virtual rewards on a second platform for completing tasks in the first platform.

U.S. Pat. No. 9,517,403 discloses a system and method for providing rewards for creating custom items in a virtual space. Rewards are determined based on user reviews of the created custom item.

U.S. Pat. No. 9,573,051 discloses a system for adjusting probabilities of receiving virtual rewards in a game space based on user usage rates of the game.

U.S. Pat. No. 10,086,287 discloses a method for providing virtual rewards determined by Gameco servers in a gaming environment for completing real-world activities based on opportunity notifications.

Known systems have sought to unite a user's real world activities with his online activities. But this focus has been too narrow and thus have not gained much acceptance. The focus is narrow because a user's online activity goes beyond games to anything where the user receives intangible benefit as a result of a tangible activity. The intangible benefits may subsequently be converted into a tangible benefit.

### BRIEF SUMMARY OF THE INVENTION

The embodiments of the present invention concerns a system and method of rewarding participants in multiple loyalty programs for completing device-tracked real world activities. Rewards may include in a computer game loyalty program features such as items, levels, or other electronic content within a game; in a hair salon loyalty program free haircuts or discounts on products; in an airline loyalty program free flights, in-flight perks such as WiFi or meals, or upgrades. Each time users use registered devices such as wearables, appliances, medical devices, point of sale (POS) systems, other embedded systems, or websites, they may receive rewards in multiple registered loyalty programs. The types of rewards received by users are determined by the sponsor of the loyalty program based on a point system determined by a point provider. A point provider is a system that may obtain a user's activity data from device-tracking servers or the tracking device itself, categorize and convert the activity into points based on predetermined formulas, and deliver the points to each of the user's registered loyalty programs.

With these and other aspects of the present invention, a user's loyalty program experience may be improved by decoupling the loyalty program from larger real world activity. Further, real world activity is not directly limited to controlling mechanisms and may be broadened and improved without disturbing the loyalty program experience. Still further, loyalty program rewards may incentivize users to engage in higher quantities of real world activity that may be beneficial to the sponsor of the loyalty program. More advantages and features of the present invention will become hereinafter apparent from the attached figures and detailed description set forth.

Further areas of applicability of the present invention will become apparent from the detailed description provided hereinafter. It should be understood that the detailed description and specific examples, while indicating the preferred embodiment of the present invention, are intended for purposes of illustration only and are not intended to limit the scope of the present invention.

Neither this summary nor the following detailed description defines or limits the present invention. The present invention is defined by the claims.

### BRIEF DESCRIPTION OF DRAWINGS

The present invention will become more fully understood from the detailed description and accompanying drawings, wherein:

FIG. 1 is a schematic of the framework of the prior art whereby activities of a user may be used to achieve rewards in a loyalty program.

FIG. 2 is a schematic of the framework of the present invention whereby activities of a user may be used to achieve rewards in disparate loyalty programs.

FIG. 3 is a schematic of a tracking device that may be used by the framework of the present invention.

FIG. 4 is a schematic of a second embodiment of a tracking device that may be used by the framework of the present invention.

FIG. 5 is a schematic of the device server of the framework of the present invention.

FIG. 6 shows a flowchart of the registration and filter configuration process undertaken by a user when registering their tracking device.

FIG. 7 is a schematic of the point provider server of the framework of the present invention.

FIG. 8a shows the categorization that may be made by the Point Provider Server's Processing Module when the user has completed an exercise run.

FIG. 8b shows the categorization that may be made by the Point Provider Server's Processing Module when the user has completed a massage.

FIG. 9 shows a flowchart of the registration process to be followed by a sponsor of a loyalty program when registering their loyalty program with the framework of the present disclosure.

FIG. 10 shows a flowchart of the registration process to be followed by a user who wishes to select a set of loyalty programs to participate in.

### DETAILED DESCRIPTION OF THE INVENTION

The following description of the preferred embodiment(s) is merely exemplary in nature and is in no way intended to limit the invention, its application, or uses.

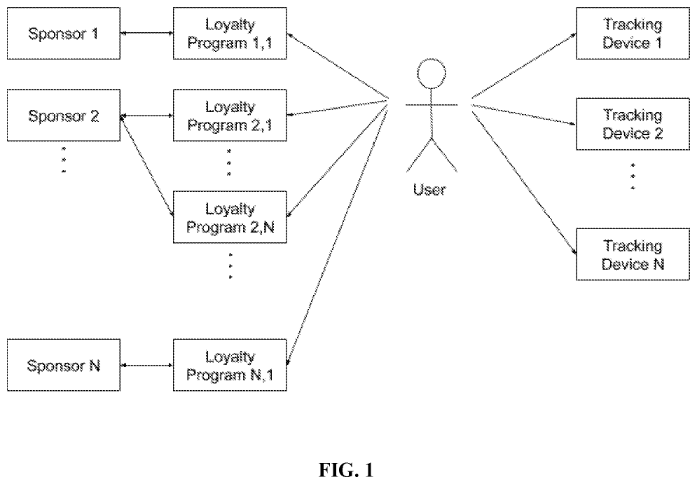

FIG. 1 shows a user who makes use of any number of loyalty programs according to the prior art. Each loyalty program has one sponsor but a sponsor may have multiple loyalty programs. In FIG. 1 loyalty programs are indexed first by the sponsor and second by its own distinct count. In FIG. 1 Sponsor 1 has one loyalty program indexed 1, 1. The first index is the same as a sponsor's index, being 1 in this case, while the second index is the distinct count of the loyalty program. So in FIG. 1 Sponsor 1 has one loyalty program. A better example are loyalty programs 2, 1 and 2, N. Here these loyalty programs are sponsored by Sponsor 2 as identified by the first index while the N in the second index indicates the total number of loyalty programs. Thus Sponsor 2 may have two or more loyalty programs. The total number of loyalty programs in which the user is enrolled in is shown by Sponsor N. A loyalty program is a program created by a sponsor to encourage users, through various rewards, to participate in the loyalty program. A participant in a loyalty program receives a reward through the loyalty program after completing a particular act. A common type of loyalty programs utilize credit cards from major airlines whereby users who are enrolled in the loyalty program, that is they have applied for and obtained the proper credit card, will be awarded points by the airline company when using the credit card for a purchase. The point may subsequently be exchanged for a passage on flights provided by the airline. Other common loyalty programs include hair salons or car washes where after the tenth purchase of a haircut or carwash, the next haircut or carwash is free. Loyalty programs have some sort of means to track a user's activities in order to active a reward. A credit card is a very useful tracking device as the item purchased, date and time, and vendor information are all recorded. Users are also careful with their credit cards as theft of the credit card could cause financial harm. Many small businesses use a hole punch card where a hole is punched into the card every time the user performs a desired task such as getting a haircut. In FIG. 1 the User is shown using N tracking devices where N represents the total number of tracking devices.

A drawback with loyalty programs is for the user to remember to use the acquired points or losing the particular tracking means or device for the program. That is the user will need to use the particular credit card associated with the loyalty program or need to remember to bring to their haircut appointment the hole punch card that is used for tracking the number of haircuts that have been paid for. In addition, many times loyalty programs do not “cross over”, that is if you make a purchase using the credit card of one loyalty program you will not receive a benefit in another credit card loyalty program. For example, say you purchased a bag of your favorite coffee using a credit card loyalty program. You would have to take the extra step of sending to your favorite coffee manufacturer proof of purchase of the bag of coffee because the two loyalty programs do not “cross over” or share information between them. Also, given the widespread use of mobile devices and internet technology, loyalty programs could be greatly expanded. For example, a clothing manufacturer could, by embedding certain electronics within their clothing, give you rewards each time you wear their clothing; a teacher could, with tracking software on a student's computer, give a student rewards for watching online documentaries; a health club, by an association with a game computer, award you health points in the game when you spend time at the health club; a vendor, say Starbucks, could award you points towards a free purchase when you purchase their coffee at the supermarket regardless of how you make that purchase. However it is not possible to achieve loyalty programs of this degree because the various tracking device manufacturers and loyalty program sponsors are different entities and while tracking devices such as our mobile devices or wearables track much of what we do, that information is not accessible to the sponsors of the loyalty programs. Referring back to FIG. 1 we see that the tracking devices on the right do not communicate with the loyalty programs on the left. What is needed is a framework that can bridge this gap and allow sponsors to retrieve a user's action from any number of tracking devices without having to know each type of tracking device.

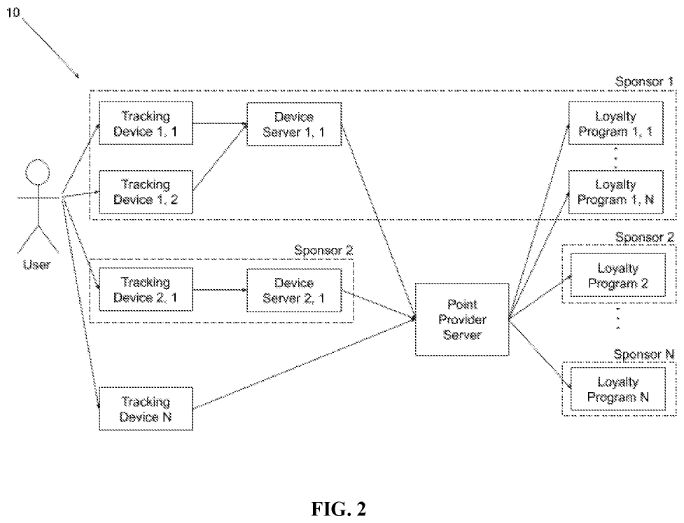

FIG. 2 shows framework 10 of the current invention and displays on the left a User with multiple tracking devices. A tracking device could typically be a credit card but in reality many products that we use may be a tracking device. For example, the User's washing machine could record the number of loads that has been washed, the automobile may record the type of service and the number of miles when the automobile is serviced, fitness wearable records the number of steps taken, clothing could record the number of times it is worn, and the list goes on. In FIG. 2 Tracking Devices 1, 1 and 1, 2 are manufactured by the same entity that also maintains and controls Device Server 1, 1 and sponsors loyalty programs 1, 1 through 1, N, namely Sponsor 1. Tracking Device 2, 1 is manufactured by Sponsor 2 who also sponsors Loyalty Program 2. Finally, Tracking Device N is manufactured by an entity that does not sponsor any loyalty programs and in addition Tracking Device N communicates directly with the Point Provider Server without going through a Device Server. When communicating with a Device Server a Tracking Device may use short range communication means such as Bluetooth or Wifi or long range communication means such as the internet. Tracking Device N in FIG. 2 has its own Device Server embedded within and communicates with the Point Provider System through the internet.

A Device Server knows and understands the various Tracking Devices that communicates with it and typically the Device Server will be created and maintained by the same entity that created and maintains the Tracking Device that is communicating with it. For example, a User's smartwatch, the tracking device, could be manufactured by Samsung, a company noted for its wearable and smartphone products. The Device Server in this case would the the Samsung wearables app that is running on the User's Samsung smartphone. The User's Samsung smartwatch, the tracking device, would communicate with the Samsung wearables app, the Device Server via Bluetooth. The Samsung wearables app would then communicate with the Point Provider Server. Another example of a tracking device would be a credit card, say a Citibank credit card, that is used in a purchase transaction. A User makes a purchase with their Citibank credit card that is transmitted by a point of sale machine to Citibank's Device Server. After Citibank has processed the sale information the Citibank Device Server would then communicate the sale information to the Point Provider Server. A final example is a tracking device that communicates directly with the Point Provider Server as shown in FIG. 2 by the reference Tracking Device N. Such a tracking device has its own Device Server built into the tracking device. Tracking Device N could be a web enabled computer running a web browser with online access to the Point Provider Server at a hair salon. Through the web browser an employee at the hair salon may record that the User has paid for a haircut so that on the tenth paid haircut the User may receive a free haircut.

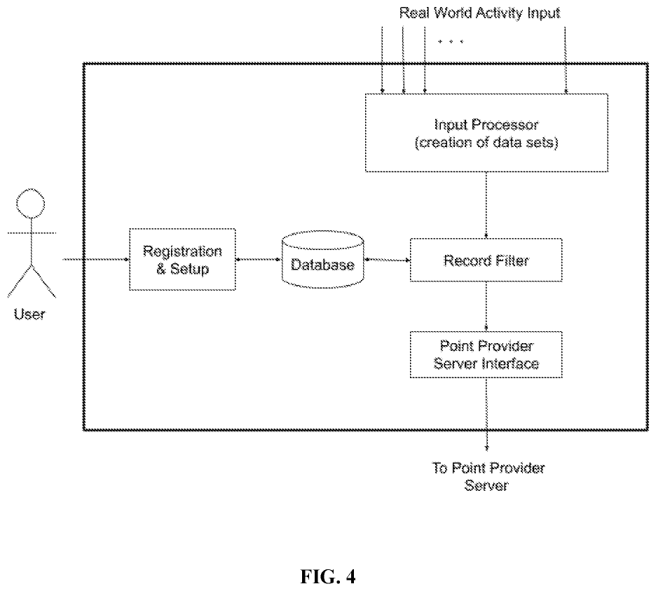

The Device Server also has an interface that is accessible by the User; allowing the User to register a particular Tracking Devices with the Device Server and to filter the type of activities that will be forwarded by the Device Server to the Point Provider Server. If a tracking device communicates directly with the Point Provider Server, such as Tracking Device N in FIG. 1, then the Device Server will be embedded in the tracking device itself as shown in FIG. 4. This registration process and filter configuration will be discussed in more detail in FIGS. 4, 5, and 6.

A Device Server communicates, through the internet, with a Point Provider Server. A Point Provider Server knows and understands the various Device Servers and Tracking Devices that are in communication with it and the Point Provider Server receives the tracking information that is being recorded, categorizes this information, stores the categorized version of the information into the database of each Loyalty Program, and finally notifies each Loyalty Program that new information has been received. While the tracking information may contain a large amount of information as discussed in the example above with the credit card, the categorized version of the information will be a data structure containing two pieces of information: the general type of activity that was being tracked and the worth of that activity. For example, say you went on a run wearing a Samsung smartwatch Tracking Device. After you have completed the run the Samsung smartwatch sends the start and end time, average pace, number of strides, GPS tracking formation, distance, heart beat, electrocardiogram (ECG), and perhaps more, to the Samsung health app found on the smartphone which also operates as a Device Server. The Samsung health app, after reviewing filtering settings configured by the User sends the same information to the Point Provider Server. The Point Provider Server will then categorize the run in multiple ways. First and most obviously as an exercise type and assign a worth related to the time spent running along with proper level of exercise intensity. Secondly, the Point Provider Server may categorize the run as a lifestyle type in that the User was outside breathing fresh air with a worth related to factors different than the exercise type such as the amount of time spent outside. Thirdly, the Point Provider Server may categorize the run as a health type with a worth related to factors different than the exercise or lifestyle types. The Point Provider Server then updates each of the Loyalty Program databases with each of these categorized versions of the run and then notifies each of the Loyalty Programs of the update. As another example, say the haircut example provided earlier, the Point Provider Server categorizes the haircut as a lfestyle type with an assigned worth and updates each of the Loyalty Program databases with this categorization. A Loyalty Program, upon receiving a notification from the Point Provider Server, may then check their database and if the type of activity that was recorded is desired, then the worth may be translated into some benefit that may be exchanged by the User for some benefit or left in the database to accrue for a larger benefit. For example, say the Loyalty Program is an online first player shooter video game and the User has completed the run discussed above. The game may allow the User, by the accumulation in the exercise type, to increase their character's strength while also allowing the User, by the accumulation in the health type, increase their character's constitution.

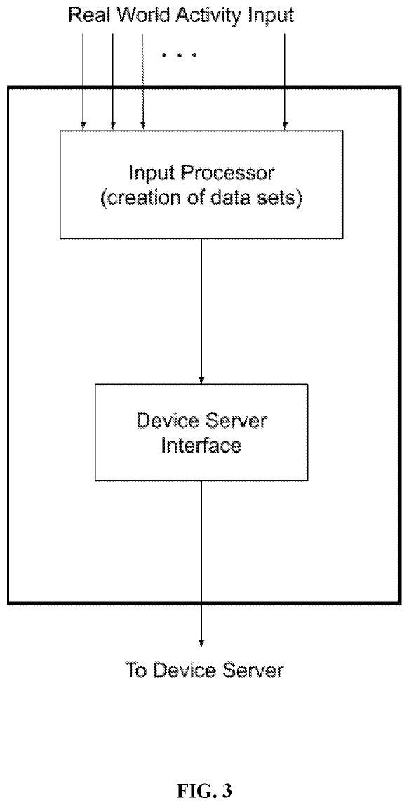

FIG. 3 shows a detailed schematic view of a Tracking Device that communicates with a Device Server with the flow of the view being from top to bottom. Along the top of the Tracking Device is shown the Real World Activity Input being received from sensors, computerized data entry, or by other means, by the Tracking Device. Sensor readings are found on many fitness wearables, computerized data entry could be received from point of sale machine, and manual data entry in the web enabled computer where an individual directly enters the required activity information. The Real World Activity Input is analyzed by the Input Processor so that it may be aggregated, sorted, parsed, and then organized into data sets to be received by the Device Server. An example of a tracking device that communicates with a device server could be a point of sale machine. Real World Activity Input would be information captured by the barcode read of the purchased product along with a scan of the credit card used. The Input Processor would analyze the barcode and credit card information to create a data set that is sent to the Device Server. A second example of a tracking device that communicates with a device server could be a fitness wearable, such as a smartwatch, that is in Bluetooth communications with the wearable's associated fitness app on a smartphone that functions as a Device Server. Real World Activity Input would be the various sensors on the fitness wearable. The Input Processor on the fitness wearable would analyze the sensors and create data sets that are sent to the fitness app/Device Server on the smartphone.

FIG. 4 shows a detailed schematic view of an embodiment of tracking device that has within it an embedded Device Server and communicates directly with a Point Provider Server where the flow of information generally proceeds from top to bottom and from left to right. Such a tracking device is shown in FIG. 2 as Tracking Device N. Along the top of the Tracking Device is shown the Real World Activity Input being received from sensors, computerized data entry, or by other means, by the Tracking Device. Sensor readings are found on many fitness wearables, computerized data entry could be received from point of sale machine, and manual data entry in the web enabled computer where an individual directly enters the required activity information. The Real World Activity Input is analyzed by the Input Processor so that it may be aggregated, sorted, parsed, and then organized into data sets. The data sets are then filtered, according to privacy parameters previously set by the User, prior to being sent to the Point Provider Server. An example of such a tracking device could be found in a massage parlor where the Tracking Device is a web enabled computer running a web browser with online access to the Point Provider Server. A client of the massage parlor would first be registered and then be allowed to configure their privacy settings to determine what information related to their massage is to be forwarded to the Point Provider Server. After receiving their massage, the employee at the massage parlor would enter the information related to the massage into the web browser where the information is analyzed by the Input Processor, filtered according to the settings previously made by the user, and then forwarded to the Point Provider Server.

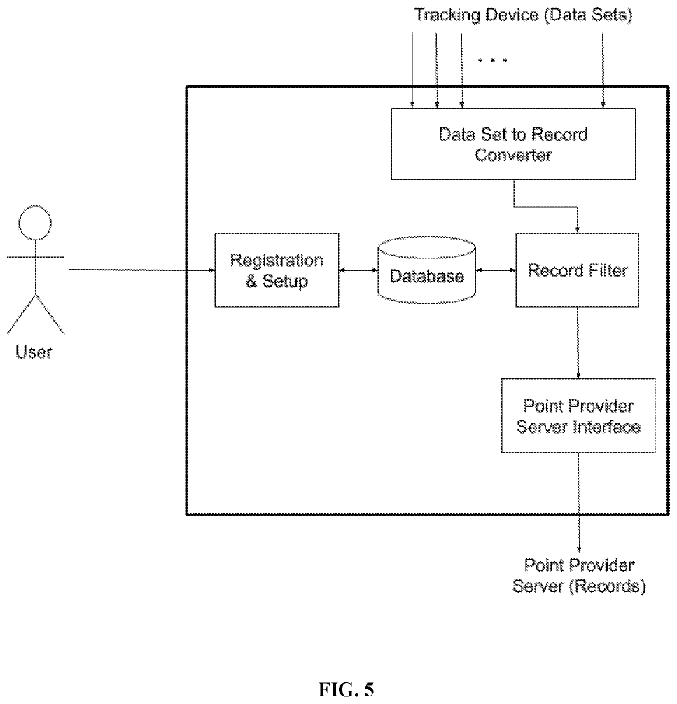

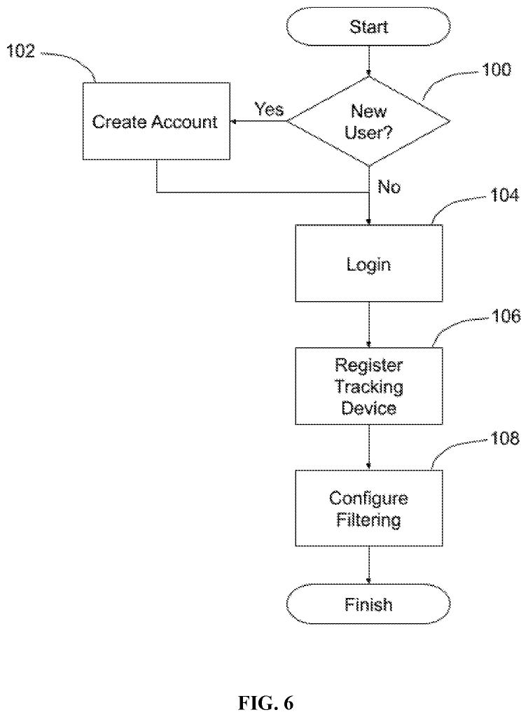

FIG. 5 shows a detailed schematic view of a Device Server with the flow of the view being from top to bottom and from left to right. Along the top of the Device Server are shown the one or more Tracking Devices that are connected to the Device Server. This connection could be provided through Bluetooth, WiFi, the internet, or many other communication means. The flow of information from the Tracking Devices to the Point Provider Server is from top to bottom. At the left of the Device Server the User is shown. When the User receives a Tracking Device, they must first go through a registration and setup process with the Device Server. The flow of registering and setting up a Tracking Device is from left to right. More on registering and setting up a Tracking Device with a Device Server when discussing FIG. 6 below but an important part of the registration process is for the user to configure what records of information the Device Server will transmit to the Point Provider Server. A User interested in greater privacy will configure the Device Server to filter much, if not all, of the records that are sent onward to the Point Provider Server. A User interested in maximizing their participation in any Loyalty Programs will filter little, if any, of the records that are sent onward to the Point Provider Server. Filtering settings are saved in the Database shown in FIG. 5.

As an example of registering and configuring a Tracking Device, say the Tracking Device is an automobile manufactured by Ford Motor Corporation. The Device Server would be a web server also owned by Ford Motor Corporation. During the registration and setup process the User would not only register the automobile with the Device Server but also (i) link the automobile to himself as the Owner and (ii) activate whatever filtering is to be done on the records that are to be sent to the Point Provider Server. In this way the User may keep private what information is not to be sent to the Point Provider Server. After the User has registered and setup the automobile the Device Server is ready to accept the data sets that are received from the automobile. These data sets may detail a variety of tracking information that is captured by the automobile's on board computer such as speed, service warnings, environmental settings, gasoline efficiency, and more. When the Device Server receives these data sets from the automobile, the Device Server will convert the data sets of activity information into records that are readable by the Point Provider Server. Prior to sending the record to the Point Provider Server a check is made with the User's configuration settings that are saved in the Database to determine if the record is to be kept private. If the record is to be kept private it is discarded.

To register a Tracking Device that is to communicate with a Device Server the User will need to perform the steps shown in the flowchart of FIG. 6. In 100, at the start of the process, the User will be asked if they have previously created an account. If they are new to framework 10, the User will create a new account as shown in 102 and then proceed to log into framework 10 in 104. If the User has previously created an account they will proceed directly to log into framework 10 in 104. In 106 the User will register the Tracking Device. Tracking Devices and Device Servers are sourced and maintained by the same or related entities. For example, a Samsung smartwatch (the Tracking Device) will pair with the Samsung Health app on a smartphone (the Device Server). Another example, a Ford Motor Corporation automobile (the Tracking Device) will pair with a Ford Motor Corporation webserver (the Device Server). A final example, a Sony camera (the Tracking Device) will pair with a third party webserver (the Device Server) that is contracted by Sony. Once the Tracking Device is registered with framework 10 it will communicate activity information to the Device Server and the activity information will be linked to the User. Finally in 108 the User will select what categories of activities tracked by the Tracking Device will be filtered and discarded by the Device Server. In this manner the User may determine what level of privacy they wish to enjoy in framework 10. After the User has configured the amount of filtering that the Device Server is to perform on the activity information sent by the Tracking Device the User is complete and the Tracking Device is now ready to send activity information to the Device Server and the Device Server will be able to link the activity information to the User. The entity that owns the Device Server will be able to retrieve whatever information is sent by the Tracking Device and then filter out the activity information that is to be kept private prior to forwarding to the Point Provider Server.

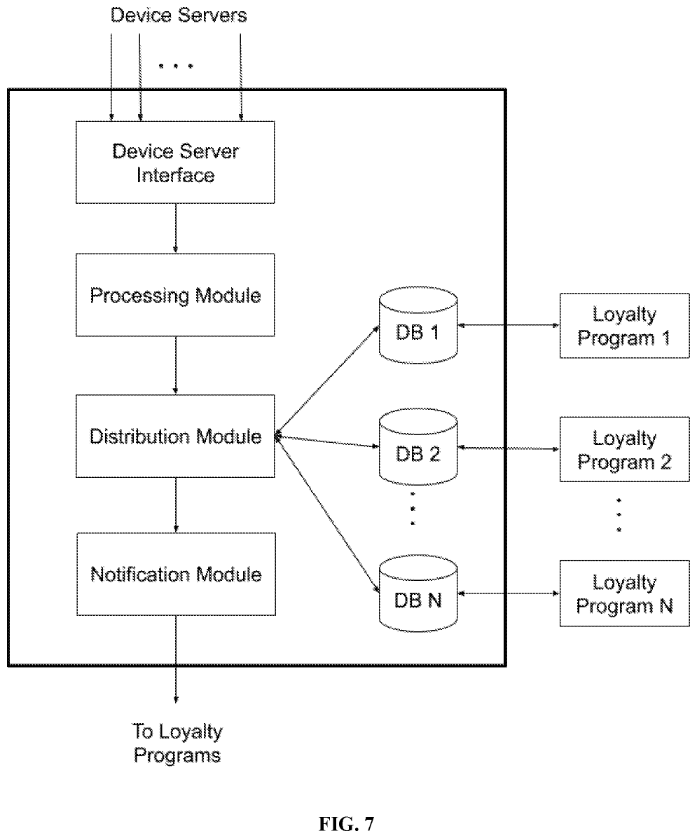

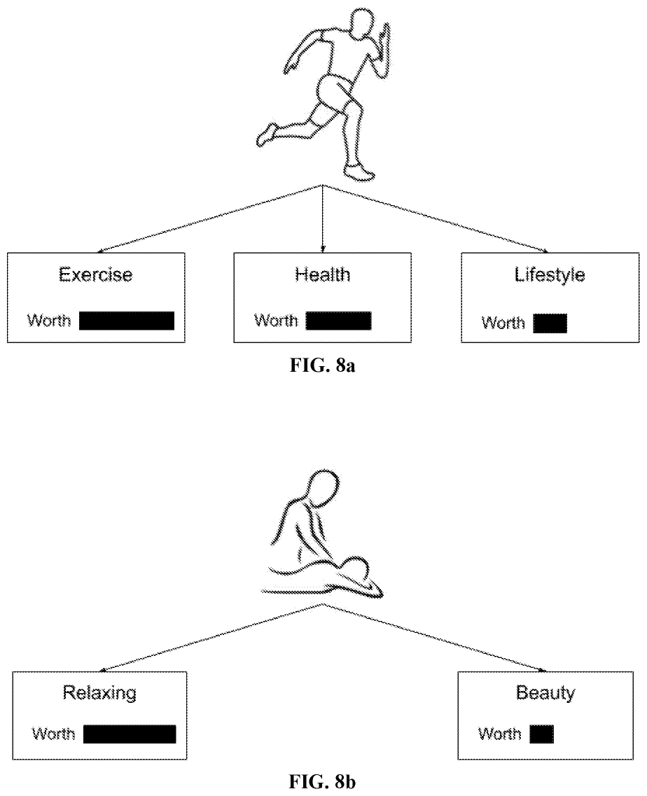

FIG. 7 shows a schematic view of the Point Provider Server where the flow of information generally proceeds from top to bottom and from left to right. At the top is shown one or more Device Servers that are in communications with the Point Provider Server. As previously noted, each of the device servers are typically controlled by the same entity that manufactures the tracking device that communicates with the device server. Thus a Garmin fitness wearable would communicate with a Garmin device server or a Maytag washing machine would communicate with a Maytag device server. However the Point Provider Server stands alone in the framework of the present disclosure. Thus the single Point Provider Server will likely have thousands of device servers sending records of information representing activities of users who are participating. The records from the Device Servers are first analyzed by the Processing Module. The purpose of the Processing Module is to categorize each activity record that has been received from a Device Server into one or more data structures containing two values—a type and a worth. Multiple data structures are used because a single activity may be categorized in many different ways. However the worth of an activity depends upon how closely the activity is related to the type assigned to it. This is shown in FIG. 8a and 8b. In FIG. 8a the activity shown is a run. A run could be categorized as an exercise, lifestyle, health, and perhaps other categories. The worth assigned to the type would vary depending upon the how related the activity is to the type that is being assigned to the activity. This is represented by the bar graph below the type. As an exercise, a run is worth its full worth as shown by the full bar graph in the Exercise box. However, as a health activity, the worth of a run is something less than its full worth. Finally, as a lifestyle activity, the worth of a run is something far less than its full worth. As a second example consider FIG. 8b where the activity shown is a massage. A massage could be categorized as a relaxing, beauty, lifestyle, and perhaps other types of categories. The worth assigned to the type would vary depending upon the how related the activity is to the type that is being assigned to the activity. This is represented by the bar graph below the type. As a relaxing activity, a massage is worth its full worth as shown by the full bar graph in the Relaxing box. However, as a beauty activity, the worth of a massage is something less than its full worth. Finally, as a lifestyle activity, the worth of a massage is something far less than its full worth.

Once the record has been categorized into a type and a worth has been determined for that type, the record will be discarded and the one or more data structures containing the type and worth will be given to the Distribution Processor. The Distribution Processor will receive the data structure and update each of the databases, represented by DB 1 through DB N, with the data structure. Thus if a data structure comprised a health type and its associated worth, the Distribution Processor will update each of the databases by adding to the health type stored in the database the worth of the health type in the data structure. Once this is done the data structure is then passed on to the Notification Processor and the Notification Processor will then notify each of the Loyalty Programs that its database has been updated with the information contained in the data structure. It is then up to the Loyalty Programs themselves to determine if the update is important and how the worth of the activity may be exchanged into a reward.

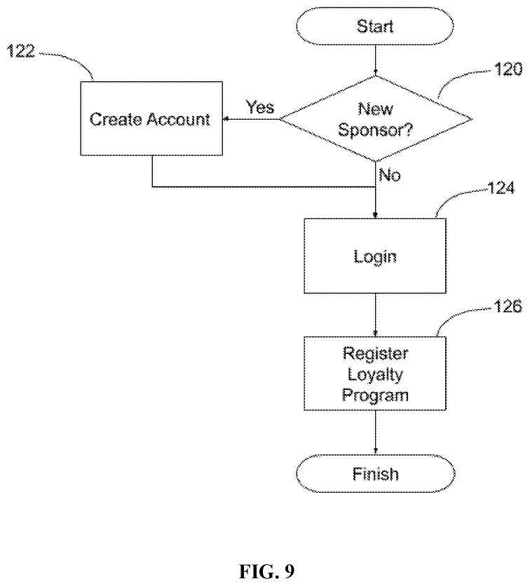

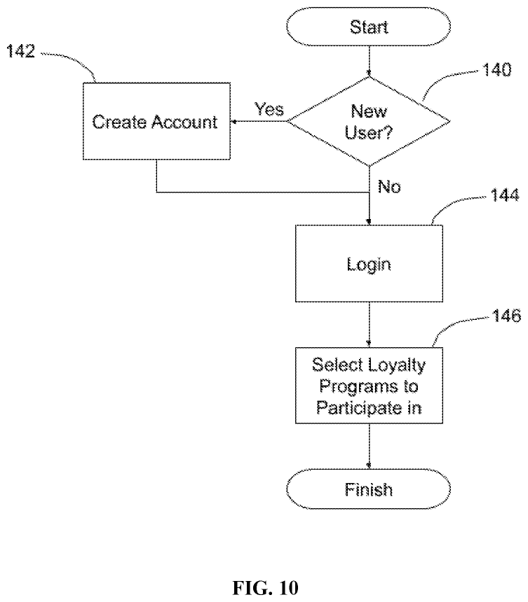

To register a loyalty program with the Point Provider Server, the Sponsor of the loyalty program will need to perform the steps shown in the flowchart of FIG. 9. In 120, at the start of the process, the Sponsor will be asked if they have previously created an account. If they are new to framework 10, the Sponsor will create a new account as shown in 122 and then proceed to log into framework 10 in 124. If the Sponsor has previously created an account they will proceed directly to log into framework 10 in 124. In 126 the Sponsor will register the Loyalty Program. When the Sponsor has registered a loyalty program with the Point Provider Server, a database is created for the Loyalty Program as shown in FIG. 7 as DB 1, DB 2, to DB N. Each loyalty program will have one database. After the Loyalty Program has completed the registration process the Point Provider Server will begin to update the database with any new activity performed by a user that is participating in the Loyalty Program. A user selects a set of loyalty programs to participate in by performing the steps shown in the flowchart of FIG. 10. In 140, at the start of the process, the User will be asked if they have previously created an account. If they are new to framework 10, the User will create a new account as shown in 142 and then proceed to log into framework 10 in 144. If the User has previously created an account they will proceed directly to log into framework 10 in 144. As part of the account creation process, or in subsequent logins, the User may enter identifying information that the Point Provider Server will use to link activities being received from a tracking device or a device server to the User. Finally in 146 the User will select the one or more loyalty programs they wish to participate in. At this point framework 10 has all of the necessary information to receive a user's tracked activity and to save it to a loyalty program. The user may then exchange the points received for a tracked activity for certain benefits or the loyalty program may distribute any benefits directly to the user after a certain number of points have been acquired. For example, say an online role playing game by the name of Dragon Master has registered itself with the Point Provider Server by following the flowchart in FIG. 9 and that a user by the name of George had (i) previously registered a fitness tracking device with a device server and (ii) previously selected to participate in a registered loyalty program sponsored by a local gym called All Day Fitness. George had configured the filtering in step 108 of FIG. 6 to send GPS and length of the visit to All Day Fitness to the Point Provider Server. Each time George went to All Day Fitness he would receive points for the visit that would vary according to the length of his visit. This information would be sent to the database in the Point Provider Server for All Day Fitness where it is recorded and may subsequently be exchanged by George for t-shirts or other offerings by All Day Fitness. Then George purchases Dragon Master and decides to participate in their loyalty program after discovering that the intensity of a workout will improve his character's strength. George will then login into the Point Provider Server and select to participate in the Dragon Master loyalty program as shown in step 146 of FIG. 10. George will also need to log into the device server for his fitness wearable and change the filtering settings in step 108 of FIG. 6 to permit heart rate to be sent to the Point Provider Server along with the GPS and timing information. Now when George visits All Day Fitness to perform a workout not only is his visit and the length of his visit sent to the Point Provider Server but also his heart rate is sent to the Point Provider Server. When the Point Provider Server receives this information (i) the database for the All Day Fitness loyalty program will be updated with the same data structures as before so that George may exchange points for t-shirts and other such offerings by All Day Fitness and (ii) the database for Dragon Master will be updated with data structures to show that George had performed a workout and the intensity of the workout. Dragon Master, upon receiving notification from the Point Provider Server's Notification Module shown in FIG. 7, may then increase George character's strength.

Although the present framework has been described in detail for the purpose of illustration based on what is currently considered to be the most practical and preferred implementations, it is to be understood that such detail is solely for that purpose and that the framework is not limited to the disclosed implementations, but, on the contrary, is intended to cover modifications and equivalent arrangements that are within the spirit and scope of the appended claims.

What is claimed is:

1. A computer framework whereby real-world activity by a user grants to the user points into one or more disparate loyalty programs enrolled by the user the framework to exchange for one or more rewards consisting of:
one or more loyalty programs registered by a sponsor for which a database is created and the user has enrolled into the loyalty program;
one or more activity tracking devices to receiving a user's real-world activity as data sets and to send the data sets to a device server;
a device server capable of reading the data sets received from the tracking device, aggregating the data sets into records, and forwarding the records to a point provider server;
a point provider server capable of receiving the records from the device server the point provider server further comprising:
a processing module to convert the records into one or more data structures,
a distribution module to update the database associated with a loyalty program with the data structures, and
a notification module to notify the loyalty program of the update to the database; and
wherein said enrolled loyalty programs are able to access the database to retrieve and update the data structures.

2. The computer framework of claim 1 wherein the data structure comprises two values: a value that categorizes the activity that was tracked into a type called Type and a value that indicates the worth of the activity as to the category assigned to the activity called Worth.

3. The computer framework of claim 2 wherein the database receives the Type into a first database field and the Worth into a second database field.

4. The computer framework of claim 3 wherein the distribution module will insert into the database those data structures whose Type does not exist in the first database field and will aggregate to the second database field the Worth where the Type does exist in the first database field.

5. The computer framework of claim 1 wherein the device server is embedded into the tracking device, the tracking device therefore receiving a user's real-world activity as data sets, aggregating the data sets into records, and forwarding the records to a point provider server.

6. The computer framework of claim 5 wherein the tracking device filters the records prior to forwarding the records to a point provider server to discard certain records according to privacy parameters previously set by the user.

7. The computer framework of claim 5 wherein the user registers a tracking device comprising the steps of:
creating an account on a tracking device;
logging into the account;
registering the tracking device; and
configuring the privacy parameters for the tracking device.

8. The computer framework of claim 1 wherein the device server filters the records prior to forwarding the records to a point provider server to discard certain records according to privacy parameters previously set by the user.

9. The computer framework of claim 1 wherein the user registers a tracking device comprising the steps of:
creating an account on a device server;
logging into the account;
registering the tracking device; and
configuring the privacy parameters for the tracking device.

10. The computer framework of claim 1 wherein the sponsor registers a loyalty program comprising the steps of:
creating an account on the point provider server;
logging into the account; and
registering the loyalty program.

11. The computer framework of claim 1 wherein the user enrolls in a loyalty program comprising the steps of:
creating an account on the point provider server;
logging into the account; and
selecting the loyalty program to be enrolled into.
